(19) United States
(12) Patent Application Publication
(10) Pub. No.: US 2024/0178644 A1
(43) Pub. Date: May 30, 2024

(54) OUTLET APPARATUS FOR VEHICLE

(71) Applicant: HYUNDAI MOBIS CO., LTD., Seoul (KR)

(72) Inventor: Moon Sub HWANG, Yongin-si (KR)

(73) Assignee: HYUNDAI MOBIS CO., LTD., Seoul (KR)

(21) Appl. No.: 18/366,953

(22) Filed: Aug. 8, 2023

(30) Foreign Application Priority Data
Nov. 25, 2022 (KR) 10-2022-0160131

(51) Int. Cl. H02G 11/02; H01R 25/00

(52) U.S. Cl. CPC H02G 11/02; H01R 25/003; H01R 2201/26

(57) ABSTRACT

An outlet apparatus for a vehicle includes: an outlet body installed inside a vehicle, the outlet body configured to house a multitap; the multitap detachably attached to, and housed within, the outlet body, and including power outlets formed to mate with electrical connectors; and a cable providing electrical connectivity between the multitap and a power source of the vehicle that is configured to supply power to the multitap via the cable, wherein the cable is configured to extend from the outlet body when the multitap is detached from the outlet body.

### CROSS-REFERENCE TO RELATED APPLICATIONS

This application claims priority under 35 USC § 119(a) to Korean Patent Application No. 2022-0160131, filed on Nov. 25, 2022, the disclosure of which is incorporated herein by reference in its entirety.

### BACKGROUND

### 1. Field

The present disclosure relates to an outlet apparatus for a vehicle, and more specifically, to an outlet apparatus for a vehicle, through which power of a battery mounted on an electric vehicle is supplied to the outside.

### 2. Description of Related Art

With an increase in vehicle camping, increased demand for using vehicles like private offices, and a rising population, the use of “vehicle to load (V2L)” for supplying power in a vehicle to the outside to use general electrical appliances is increasing.

In particular, when power is supplied using power of a battery mounted in an electric vehicle, in the case of an indoor V2L outlet apparatus applied to an electric vehicle, since a position of the indoor V2L outlet apparatus is fixed, there is a restriction of a position in an interior in which the indoor V2L outlet apparatus is used when an electrical appliance having a short power cable is used. That is, since an electrical appliance is used only around the outlet apparatus, a user is uncomfortable.

In addition, in the case of a present outlet apparatus, since only one or two plugs may be connected to the outlet apparatus for use, when a plurality of electrical appliances are used, there is an inconvenience of additionally connecting a multitap for use.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In addition, the present disclosure is directed to providing an outlet apparatus for a vehicle, which allows a plurality of electrical appliances to be easily used at the same time because a multitap for using the plurality of electrical appliances is included.

In addition, the present disclosure is directed to providing an outlet apparatus for a vehicle with a structure in which a cable is automatically wound after an electrical appliance is used so that there is no need for additional arrangement or storage and the cable is neatly stored without being exposed to the outside.

Objectives to be solved by the present disclosure are not limited to the above-described objectives, and other objectives which are not described above will be clearly understood by those skilled in the art from the following description.

According to an aspect of the present disclosure, an outlet apparatus for a vehicle includes: an outlet body installed inside a vehicle, the outlet body configured to house a multitap; the multitap detachably attached to, and housed within, the outlet body, and including power outlets formed to mate with electrical connectors; and a cable providing electrical connectivity between the multitap and a power source of the vehicle that is configured to supply power to the multitap via the cable, wherein the cable is configured to extend from the outlet body when the multitap is detached from the outlet body.

The multitap may be formed in a cuboid shape, and outer surfaces of the multitap may respectively include the outlets.

The multitap may include a front surface facing away from the outlet body and includes a gripping groove configured to be gripped by fingers when detaching the multitap from the outlet body.

The gripping groove may be formed in a corner position of the multitap.

The gripping groove may include a curved shape and may be recessed in a corner portion of the front surface of the multitap.

The outlet body may include: a seating receptacle recessed in the outlet body; and a cover configured to open and close over the seating receptacle when the multitap is attached to the outlet body within the seating receptacle.

The multitap and the seating receptacle may be configured to provide a magnetic attraction force that attaches the multitap to the seating receptacle.

The cable may be mechanically connected to an elastic member and may be wound around the elastic member, and the elastic member may provide a rotational elastic force in a direction in which the cable is wound around the elastic member.

A locking member may be engaged with the elastic member that may be configured to lock is correspondence with the cable being pulled outward from the outlet body, and when the locking member is locked the elastic member may exert a retraction force on the elastic member which prevents retraction of the cable.

The locking member may be configured to unlock in correspondence with a retraction of the cable.

The elastic member may include a spiral spring.

A shape of a recess in the outlet body may be the same as a shape of the multitap.

In another general aspect, an outlet apparatus includes: a multitap body including faces respectively including electrical receptacles configured to mate with electrical connectors, the multitap body having a shape matching the shape of a multitap receptacle; a housing body including the multitap receptacle, wherein the multitap receptacle is configured to detachably house the multitap body; and a conductive cable connected to the multitap body and electrically connected with the electrical receptacles, wherein the outlet apparatus is configured to allow the conductive cable to extend out of the housing body in correspondence with extraction of the multitap body from the multitap receptacle.

The outlet apparatus may be included in the passenger compartment of a vehicle.

The shape of the multitap body may be cuboid, and one of the faces of the multitap body may be an outer face that faces away from the housing body when the multitap body is within the multitap receptacle, and the outer face may include notches configured for finger placement therein.

The faces of the multitap body may include two side faces that face in opposite directions relative to each other.

The faces of the multitap body may include another side face that is perpendicular to the two side faces.

The housing body further may include a sliding door configured to slide in one direction to cover the multitap receptacle and in another direction to uncover the multitap receptacle.

The outlet apparatus may be configured to: inhibit retraction of the electrical cable responsive to a first movement of the electrical cable, and cause retraction of the electrical cable responsive to a second movement of the electrical cable.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating an outlet apparatus for a vehicle according to one embodiment of the present disclosure;

FIG. 2 is a view illustrating a state in which a cable is wound around an elastic member;

FIGS. 3 to 6 are views illustrating a process in which an electrical appliance is connected to the outlet apparatus for a vehicle and used according to one embodiment of the present disclosure; and

FIGS. 7 to 9 are views illustrating a process in which the cable is wound and arranged after the electrical appliance is used according to one embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, orA, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Embodiments described herein may provide an outlet apparatus for a vehicle, which allows a plurality of electrical appliances to be easily used at the same time because a multitap for using the plurality of electrical appliances is included.

In addition, embodiments described herein may provide an outlet apparatus for a vehicle with a structure in which a cable is automatically wound after an electrical appliance is used so that there is no need for additional arrangement or storage and the cable is neatly stored without being exposed to the outside.

The aforementioned objectives are not limited to the above-described objectives, and other objectives which are not described above will be clearly understood by those skilled in the art from the following description.

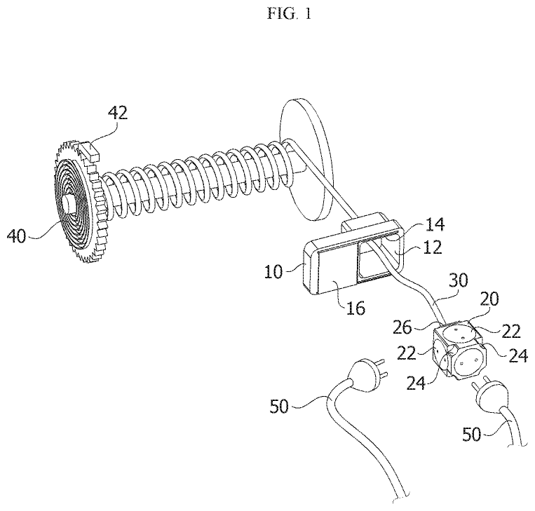

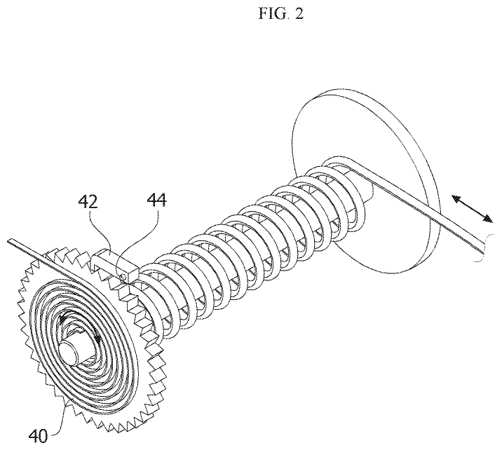

FIG. 1 is a view illustrating the outlet apparatus for a vehicle according to one embodiment of the present disclosure, and FIG. 2 is a view illustrating a state in which a cable is wound around an elastic member.

According to the illustrated drawings, the outlet apparatus for a vehicle according to one embodiment of the present disclosure may include an outlet body 10 installed inside the vehicle, a multitap 20 which is detachably mounted on the outlet body 10 and in which a plurality of outlet parts 22 to which plugs are connected are formed, and a cable 30 which is electrically connected to an interior of the vehicle for supplying power to the multitap 20 and supports the multitap 20 to extend when the multitap 20 is separated from the outlet body 10 to the outside.

The outlet body 10 may be installed inside the vehicle, for example, on a console, a rear seat, or the like for conveniently using an electrical appliance. The outlet body 10 may be formed in substantially a rectangular hexahedron shape, but is not limited thereto, and may be formed in one of various shapes.

A seating part 12 is formed on a front surface of the outlet body 10 for seating of the multitap 20. The seating part 12 is formed to be recessed inward from one side of the front surface of the outlet body 10 to correspond to a shape of the multitap 20 so that the multitap 20 is seated in the seating part 12. In addition, a through hole 14 through which a cable 30 passes is formed in the seating part 12. A cover 16 for opening and closing the seating part 12 may be coupled to the front surface of the outlet body 10. The cover 16 is slidably installed on the front surface of the outlet body 10 to open or close the seating part 12 and may have a size large enough to open or close the seating part 12. In the present embodiment, when the cover 16 slides in a left or right direction, the seating part 12 is opened or closed.

The multitap 20 is detachably mounted in the seating part 12. The multitap 20 is provided for using a plurality of electrical appliances, and outlet parts 22 for connecting the plurality of plugs are formed. The multitap 20 may be formed in one of various shapes, and, in the present embodiment, the multitap 20 is formed in a box shape, and the outlet parts 22 are formed on outer surfaces of the multitap 20 to improve a spatial efficiency. When the multitap 20 is formed in the box shape as described above, electrical appliances can be easily connected thereto in any direction such as a forward, rearward, left, and right direction, and thus user convenience is improved. An electrical appliance having a product cable 50 with one of various lengths from short to long may be easily connected to the multitap 20 in a desired direction and used.

Meanwhile, gripping grooves 24 may be formed to be recessed in corner portions of the multitap 20 so that a user grips the gripping grooves 24 to separate the multitap 20 to the outside. Each of the gripping grooves 24 may be formed in one of four corner portions of a front surface of the multitap 20 and may be formed in a curved shape recessed so that the user easily grips the gripping grooves 24 with the user's fingers. Then, for example, the user may grip the gripping grooves 24 with the user's fingers and pull and separate the multitap 20 from the seating part 12.

In this case, a magnetic part 26 may be provided on a rear surface of the multitap 20 to maintain a state in which the multitap 20 is attached to the outlet body 10. The magnetic part 26 may be attached to the rear surface so that an attractive force is applied between the magnetic part 26 and a magnetic part (not shown) provided on the seating part 12. Meanwhile, the magnetic part 26 is not necessarily provided on the rear surface of the multitap 20 and may be provided on one of various surfaces such as an upper surface and side surfaces of the multitap 20.

The cable 30 is connected to the rear surface of the multitap 20 and extends. One end of the cable 30 is electrically connected to the interior of the vehicle, and the other end thereof is connected to the multitap 20 so as to supply power. In addition, the cable 30 serves to support the multitap 20 to extend when the multitap 20 is separated from the outlet body 10 to the outside.

Since the cable 30 extends through the through hole 14 formed in the seating part 12, only when the multitap 20 is separated from the outlet body 10, the cable 30 is exposed to the outside. That is, since the cable 30 is not exposed to the outside when the multitap 20 is attached to the outlet body 10 and used, an exterior can be maintained neatly.

Meanwhile, an elastic member 40 around which the cable 30 is wound is installed in the vehicle. A spiral spring may be used as the elastic member 40, and the elastic member 40 may provide an elastic force in a direction in which the cable 30 is wound so that the user can conveniently arrange and store the cable 30.

A locking member 42 on which the elastic member 40 is caught when the cable 30 is pulled outward is provided on one side of the elastic member 40. The locking member 42 rotates about a rotary shaft 44 to restrict or release rotation of the elastic member 40.

In other words, when the user pulls the cable 30, hooking of the locking member 42 is released, and the user can pull the cable 30 to a desired length. When the user arranges the multitap 20 after using the multitap 20, the user slightly pulls the cable 30 to allow the cable 30 to be wound by an elastic force of the elastic member 40 in a state in which the hooking of the locking member 42 is released. Since the cable 30 is automatically wound by the elastic force of the elastic member 40, the user can conveniently attach the multitap 20 to the outlet body 10 to easily store and arrange the multitap 20.

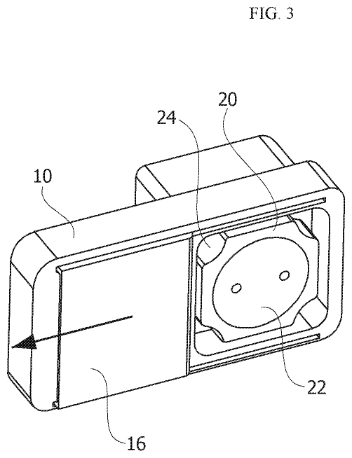

Hereinafter, an operation process of the outlet apparatus for a vehicle having the above-described structure according to the present disclosure will be described in detail. FIGS. 3 to 6 are views illustrating a process in which an electrical appliance is connected to the outlet apparatus for a vehicle and used according to one embodiment of the present disclosure.

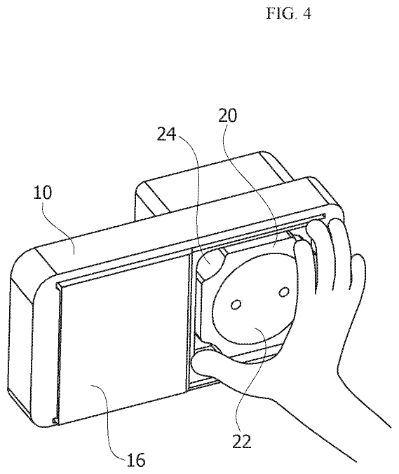

In order to connect an electrical appliance to the outlet apparatus for a vehicle, the user slides the cover 16 in the left direction to open the seating part 12 as illustrated in FIG. 3. When the seating part 12 is opened as described above, the user grips the gripping grooves 24 formed in the front surface of the multitap 20 with the fingers and then pulls the multitap 20 outward as illustrated in FIG. 4. In this case, the user may pull the multitap 20 and separate the multitap 20 from the outlet body 10 by applying a force greater than an attraction force of the magnetic part 26.

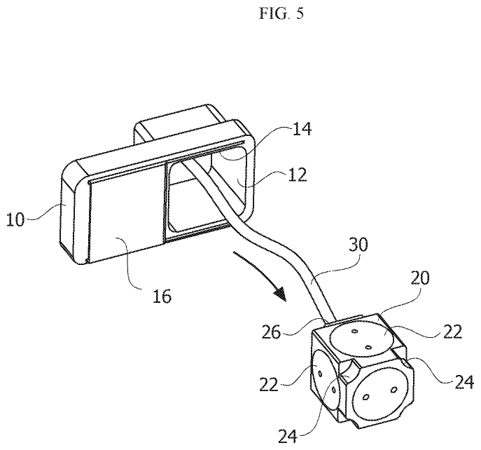

Then, the user pulls the cable 30 to a position around the electrical appliance to be used as illustrated in FIG. 5. When the cable 30 is withdrawn to the desired position, the locking member 42 is caught on one side of the elastic member 40 to maintain a state in which the cable 30 has extended.

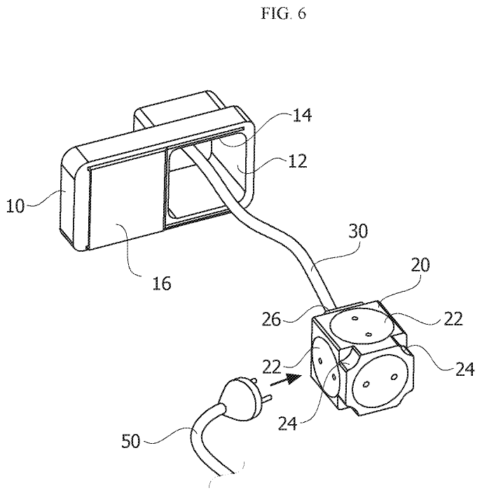

The user may use the multitap 20 by connecting a plurality of plugs to the outlet parts 22 in various directions as illustrated in FIG. 6. That is, regardless of the length of the product cable 50, a plurality of electrical appliances can be connected to the multitap 20 in various directions and used.

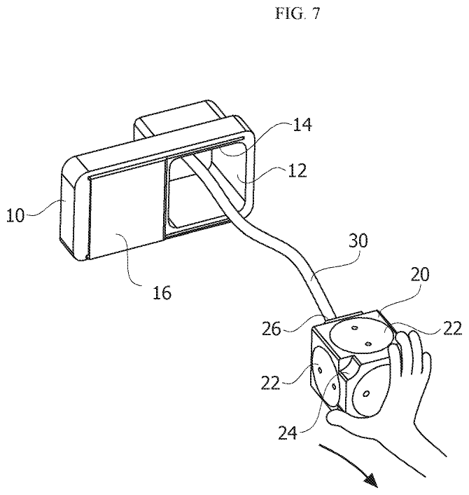

FIGS. 7 to 9 are views illustrating a process in which the cable is wound and arranged after the electrical appliance is used according to one embodiment of the present disclosure.

In order to arrange the multitap 20 and the cable 30 after using the electrical appliance, the user pulls the cable 30 back once as illustrated in FIG. 7. Then, the hooking of the locking member 42 is released, and thus the cable 30 may be introduced into the outlet body 10 along the through hole 14 by an elastic force of the elastic member 40.

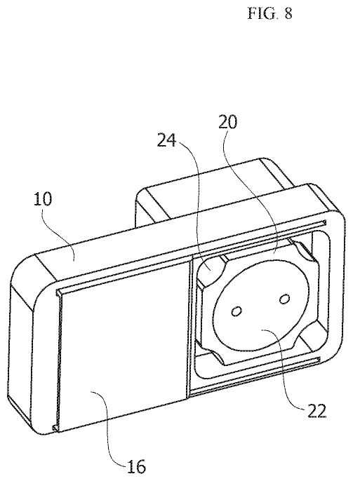

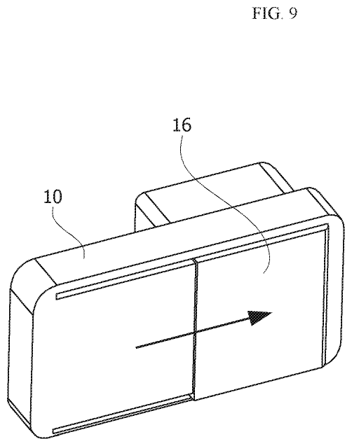

Referring to FIG. 8, the cable 30 is wound around the elastic member 40, and the multitap 20 may be attached to the seating part 12 due to a magnetic force (attraction force) of the magnetic part 26. Finally, the user closes the seating part 12 by sliding the cover 16 in the right direction as illustrated in FIG. 9.

According to one embodiment of the present disclosure, since a length of a cable of an outlet apparatus for a vehicle can extend as necessary when an electrical appliance is used inside a vehicle, the outlet apparatus for a vehicle can be freely used regardless of a length of a cable of the electrical appliance.

In addition, according to one embodiment of the present disclosure, since an outlet apparatus for a vehicle includes a multitap so that a plurality of electrical appliances can be used, the plurality of electrical appliances can be easily used at the same time.

In addition, according to one embodiment of the present disclosure, since a cable of an outlet apparatus for a vehicle is automatically wound after an electrical appliance is used, there is no need for additional arrangement or storage, and the cable can be neatly stored without being exposed to the outside.

While the present disclosure has been described above with reference to exemplary embodiments, it may be understood by those skilled in the art that various modifications and changes of the present disclosure may be formed within a range not departing from the spirit and scope of the present disclosure defined by the appended claims.

The computing apparatuses, the vehicles, the electronic devices, the processors, the memories, the image sensors, the vehicle/operation function hardware, the ADAS/AD systems, the displays, the information output system and hardware, the storage devices, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media.

Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An outlet apparatus for a vehicle, comprising:
an outlet body installed inside a vehicle, the outlet body configured to house a multitap;
the multitap detachably attached to, and housed within, the outlet body, and comprising power outlets formed to mate with electrical connectors; and
a cable providing electrical connectivity between the multitap and a power source of the vehicle that is configured to supply power to the multitap via the cable, wherein the cable is configured to extend from the outlet body when the multitap is detached from the outlet body.

2. The outlet apparatus of claim 1, wherein:
the multitap is formed in a cuboid shape; and
outer surfaces of the multitap respectively comprise the outlets.

3. The outlet apparatus of claim 1, wherein the multitap comprises a front surface facing away from the outlet body and comprises a gripping groove configured to be gripped by fingers when detaching the multitap from the outlet body.

4. The outlet apparatus of claim 3, wherein the gripping groove is formed in a corner position of the multitap.

5. The outlet apparatus of claim 3, wherein the gripping groove comprises a curved shape and is recessed in a corner portion of the front surface of the multitap.

6. The outlet apparatus of claim 1, wherein:
the outlet body comprises:
a seating receptacle recessed in the outlet body; and
a cover configured to open and close over the seating receptacle when the multitap is attached to the outlet body within the seating receptacle.

7. The outlet apparatus of claim 6, wherein the multitap and the seating receptacle are configured to provide a magnetic attraction force that attaches the multitap to the seating receptacle.

8. The outlet apparatus of claim 1, wherein:
the cable is mechanically connected to an elastic member and is wound around the elastic member; and
the elastic member provides a rotational elastic force in a direction in which the cable is wound around the elastic member.

9. The outlet apparatus of claim 8, wherein a locking member engaged with the elastic member is configured to lock is correspondence with the cable being pulled outward from the outlet body, and when the locking member is locked the elastic member exerts a retraction force on the elastic member which thereby prevents retraction of the cable.

10. The outlet apparatus of claim 9, wherein the locking member is configured to unlock in correspondence with a retraction of the cable.

11. The outlet apparatus of claim 8, wherein the elastic member comprises a spiral spring.

12. The outlet apparatus of claim 1, wherein a shape of a recess in the outlet body is the same as a shape of the multitap.

13. An outlet apparatus comprising:
a multitap body comprising faces respectively comprising electrical receptacles configured to mate with electrical connectors, the multitap body having a shape matching the shape of a multitap receptacle;
a housing body comprising the multitap receptacle, wherein the multitap receptacle is configured to detachably house the multitap body; and
a conductive cable connected to the multitap body and electrically connected with the electrical receptacles, wherein the outlet apparatus is configured to allow the conductive cable to extend out of the housing body in correspondence with extraction of the multitap body from the multitap receptacle.

14. The outlet apparatus of claim 13, wherein the outlet apparatus is comprised in the passenger compartment of a vehicle.

15. The outlet apparatus of claim 13, wherein the shape of the multitap body is cuboid, and wherein one of the faces of the multitap body is an outer face that faces away from the housing body when the multitap body is within the multitap receptacle, and wherein the outer face comprises notches configured for finger placement therein.

16. The outlet apparatus of claim 15, wherein the faces of the multitap body include two side faces that face in opposite directions relative to each other.

17. The outlet apparatus of claim 16, wherein the faces of the multitap body include another side face that is perpendicular to the two side faces.

18. The outlet apparatus of claim 13, wherein the housing body further comprises a sliding door configured to slide in one direction to cover the multitap receptacle and in another direction to uncover the multitap receptacle.

19. The outlet apparatus of claim 13, wherein the outlet apparatus is configured to:
inhibit retraction of the electrical cable responsive to a first movement of the electrical cable, and
cause retraction of the electrical cable responsive to a second movement of the electrical cable.
